(19) United States
(12) Patent Application Publication
(10) Pub. No.: US 2013/0115390 A1
(43) Pub. Date: May 9, 2013

(54) METHOD FOR PRODUCING A COMPONENT AND COMPONENT PRODUCED BY THE METHOD

(71) Applicant: SGL CARBON SE, Wiesbaden (DE)

(72) Inventors: ANDREAS KIENZLE, MOETTINGEN OT BALGHEIM (DE); INGRID KRAETSCHMER, BIBERBACH (DE); ALFRED HAEUSLER, MEITINGEN (DE); PETER POLSTER, MEITINGEN (DE)

(73) Assignee: SGL CARBON SE, WIESBADEN (DE)

(21) Appl. No.: 13/726,923

(22) Filed: Dec. 26, 2012

Related U.S. Application Data
(63) Continuation of application No. PCT/EP2011/060751, filed on Jun. 27, 2011.

(30) Foreign Application Priority Data
Jun. 25, 2010 (DE) 10 2010 030 552.9
Apr. 20, 2011 (DE) 10 2011 007 815.0

(51) Int. Cl. C04B 35/565; B32B 38/00

(52) U.S. Cl. CPC C04B 35/565; B32B 38/0004
USPC 428/34.1; 156/250; 156/62.2; 156/62.4; 428/408

(57) ABSTRACT

A method for producing a component and to a component as such made of a ceramic material having a predefined shape. The method includes providing a plurality of sheets made of carbon material), providing an adhesive containing a carbonizable component and joining the plurality of sheets to each other by the adhesive to form a sheet arrangement. The spatial dimensions of which are such that the predefined shape of the component can be generated from the arrangement by material removal. The sheet arrangement is worked by removing carbon material from the sheet arrangement to obtain a preform which is made of carbon material and has the predefined shape of the component to be produced. The perform is siliconized to obtain the component made of ceramic material.

### CROSS-REFERENCE TO RELATED APPLICATION

This is a continuation application, under 35 U.S.C. §120, of copending international application No. PCT/EP2011/060751, filed Jun. 27, 2011, which designated the United States; this application also claims the priorities, under 35 U.S.C. §119, of German patent applications No. DE 10 2010 030 552.9, filed Jun. 25, 2010 and DE 10 2011 007 815.0, filed Apr. 20, 2011; the prior applications are herewith incorporated by reference in their entireties.

### BACKGROUND OF THE INVENTION

### Field of the Invention

The present invention relates to a method for producing a component and to a component produced by the method. The present invention in particular also relates to the production of large two-dimensional structures and/or of 3D structures having a particularly homogeneous property profile.

When producing complex components having a predefined three-dimensional structure and/or extensive planar structure from a piece, the problem that an underlying material block or material combination, from which the desired three-dimensional or planar structure for the product to be produced is to be worked out, can only be prepared homogeneously with difficulty is often encountered.

The inhomogeneity concerns the material density as such, but also in particular the distribution of the individual components forming the material.

As a result, the end product once worked out from a starting material block or starting material composition, which is already inhomogeneous per se, also has inhomogeneous physical and/or chemical properties. Often, this cannot be tolerated.

### SUMMARY OF THE INVENTION

The object of the invention is to disclose a method for producing a component made of ceramic material having a predefined shape, in which a particularly high level of homogeneity for the product can be ensured in a particularly simple, yet reliable manner. Furthermore, the object of the invention is achieved with a component having a predefined three-dimensional structure made of a carbon-fiber-reinforced material.

In accordance with one aspect, the present invention provides a method for producing a component made of a ceramic material having a predefined shape. The method includes providing a plurality of sheets made of a carbon material and providing an adhesive containing a carbonizable component and joining the plurality of sheets to each other by the adhesive to form a sheet arrangement. The spatial dimensions of which are such that the predefined shape of the component can be generated from the arrangement by material removal. The sheet arrangement is worked by removing the carbon material from the sheet arrangement to obtain a preform which is made of the carbon material and has the predefined shape of the component to be produced. The perform is siliconized to obtain the component made of ceramic material.

A predetermined pressure distribution, temperature distribution, radiation and/or a process atmosphere can be applied to the produced arrangement of the encasing body or in order to form the encasing body, either when joining the sheets to each other, or once the sheets have been joined to each other, and in particular before working.

A temperature step, in particular to carbonize components of the arrangement, can be carried out on the produced arrangement of the encasing body or in order to form the encasing body, either when joining the sheets to each other or once the sheets have been joined to each other, in particular before working.

A temperature step, in particular to siliconize components of the arrangement, can be carried out in a process atmosphere on the produced arrangement of the encasing body or in order to form the encasing body, either when joining the sheets to each other or once the sheets have been joined to each other, in particular before working.

Different intermediate and post-processing steps can be carried out and offered so as to further define the material properties of the encasing body then provided or the preform of the product, that is to say once the predefined geometric manifestation of the product to be produced has been worked out.

Here, the finding according to the invention is utilized that sheet structures, whether planar or curved, can be produced with a high level of homogeneity of the material distribution, of component distribution and thus of their physical and/or chemical properties due to their relatively low layer thickness compared to solid bodies, and that a corresponding solid body, an extensive planar structure, or an encasing body having homogeneous properties substantially identical to those of the individual sheets is produced once the sheets, which are homogeneous per se, have been joined to each other.

Due to the approach according to the invention, the inhomogeneities normally occurring inherently when processing a solid body are thus avoided, in particular if identical or very similar sheets are used and if fluctuations in specific properties at the interfaces between adjacent sheets do not occur, are so low that they can be tolerated, and/or can be reduced, counterbalanced or eliminated within the scope of a post-treatment process.

The sheet arrangement is preferably formed by stacking on top of one another or joining to each other a plurality of sheets, or all sheets, by joining the underside of a sheet or subsequent sheet as a first joining face to the upper side of a sheet as a second joining face.

A solid body or encasing body is thus constructed in a particularly simple manner by simply joining the sheets to each other at their upper sides and undersides, in the form of a stack so to speak. Here, the size of the surfaces has a positive influence on the stability of the bond between adjacent sheets.

In another embodiment of the method according to the invention, one or more of the sheets may additionally or alternatively have edges or edge faces. One or more of the sheets may then additionally or alternatively be joined by at least one of their edges or one of their edge faces as a joining face to one or more sheets.

Here, one or more sheets can be joined at one or more of their edges or edge faces as a first joining face to edges or edge faces of one or more sheets as a second joining face.

It is thus also conceivable for the underlying sheets to be joined to each other at the edges or edge faces, even if these have a smaller area compared to the upper sides and undersides. Here, it is conceivable that an edge face rests on an upper side or underside of another sheet. On the other hand, it is also conceivable for two or more sheets to be interconnected via edges.

Of course, a combination in which a large encasing body or solid body is formed by relatively smaller sheets, which are interconnected on the one hand in a stacked form and on the other hand via their edge faces, is also conceivable. For example, a plurality of stacks may thus initially be formed via the upper sides and undersides, the stacks then being interconnected via the edge faces, preferably arranged in abutment. The reverse approach is also conceivable, in which smaller sheets are first joined to each other via edges to form a larger sheet and are then in turn interconnected via the upper sides and undersides in stacks.

One or more joining faces to be joined to each other can be provided with at least one connection device and/or at least one connection device can be formed between a plurality of joining faces to be joined to each other, before the joining process.

In principle, it is conceivable for the interconnected faces of the fundamental sheets to enter into a sufficient bond when contacted together, without further aids, for example if a specific pressure, possibly with the introduction of heat, is exerted.

It is often expedient, however, to take assistive measures for a durable connection of this type, one of the measures may lie in forming the sheets in a material precursor, for example in the manner of a partly cross-linked state, and then, once the individual sheets have been joined to each other, inducing a reaction inherently in the material of the joined sheets, in particular at the interfaces there-between, the reaction producing the connection between the sheets that have been joined to each other.

It is also conceivable for additional external agents to be used, such as an adhesive agent or the like. Pressure and temperature can be varied accordingly, either in addition or alternatively, so as to construct and to promote a connection of this type.

In addition, mechanical aids at the joining faces are conceivable, either alternatively or in addition.

The sheets preferably have side faces determined by the thickness of the sheets, and at least one of the sheets is joined by one of its side faces as a first joining face to the upper side or underside of another of the sheets as a second joining face.

The sheets preferably have side faces determined by the thickness of the sheets, and at least one of the sheets is joined by one of its side faces as a first joining face to one of the side faces of another of the sheets as a second joining face.

Before the joining process, a dust or powder made of the same material or from the same material class as that of the material, or a material, of the sheets can be introduced between the joining faces as a bonding agent or as part thereof. This measure is also suitable for producing a high level of homogeneity of the material distribution and of the physical and chemical properties at the transition between joining faces.

In the case of at least two of the sheets to be joined at the joining faces, a recess is preferably integrally formed in the joining face of one sheet and a protrusion shaped in a manner complementary to the recess is preferably integrally formed on the joining face of the other sheet and the two sheets are joined together by engaging the recess with the protrusion.

It is preferable if, in the case of at least two of the sheets to be joined at the joining faces, a recess is integrally formed in the joining faces of both sheets and a connection element shaped in a manner complementary to the recesses is provided, wherein the two sheets are joined together by engaging the connection element with both recesses.

The mechanical aids in the sense of recesses and plug-in elements can stabilize straight contacts at the edges, but are also provided when contacting the upper sides and undersides together, for example so as to allow sheets that are identical per se to be aligned relative to one another.

A recess can be formed as a bore, groove, channel or shoulder.

An adhesive agent can be used as a bonding agent or as part thereof. With an adhesive agent, particularly close contact between joined sheets can be produced, which also takes into account the surface structure for example, that is to say roughness or the like. In this case, the adhesive agent may advantageously be selected such that material inhomogeneities at the interfaces are not produced or are compensated.

The carbonizable portion of the adhesive preferably contains a resin, in particular a phenolic resin.

In a particularly preferred embodiment, the adhesive contains silicon carbide powder in addition to the resin. Preferred mixing ratios in this case are 42% binder and 58% SiC F1000 (silicon carbide powder) or 40.4% binder and 55.8% SiC F1000, in each case in 3.8% of a saturated para toluene sulfonic acid in water.

The silicon carbide powder has a mean particle diameter of 1-50 μm, preferably 5-20 μm, more preferably 3-5 μm.

The carbonizable adhesive contains 5-50% by weight water, 20-80% by weight silicon carbide powder and 10-55% by weight resin, preferably 10-40% by weight water, 30-65% by weight silicon carbide powder and 20-45% by weight resin, more preferably 15-25% by weight water, 45-55% by weight silicon carbide powder and 27-33% by weight resin.

The carbonizable adhesive contains less than 10% by weight, in particular less than 3% by weight, and in particular no, filler made of carbon material.

The carbonizable adhesive preferably contains between 0.5 and 5% by weight of a curing agent.

The adhesive preferably contains the material from which the sheets made of carbon material are fabricated.

The sheet arrangement is preferably carbonized and the preform is preferably carbonized.

The sheets are subjected to pressure and/or heat when joined together.

It is preferable if the physical and/or chemical properties of some, in particular all, sheets are identical over the spatial expansion of the sheets in question.

At least some of the sheets preferably have a spatial expansion (length×width×thickness) in the range from 20-80 cm (length)×20-80 cm (width)×3-10 cm (thickness).

In a particularly preferred embodiment, some, in particular all, sheets have the same composition of the carbon material, considered among one another.

Some, in particular, all of the sheets are preferably produced by preparing a homogeneous mixture with carbonizable, powdery binder and carbon fibers, compacting the mixture under the action of pressure and molding it into a sheet-shaped preliminary product and further processing the sheet-shaped preliminary product by carbonization, or by carbonization and graphitization, to form a sheet made of carbon material. Preferred mixing ratios of binder and fibers are 30% binder and 70% carbonizable cellulose fibers or 29.3% binder, 68.3% carbonized cellulose fibers and 2.4% paraffin.

It is preferable if the powdery binder is phenolic resin powder, in particular with a particle size distribution D₅₀<100 μm.

The homogeneous mixture contains 20-50% by weight of the binder and 50-80% by weight of the carbon fibers, preferably 30-40% by weight of the binder and 60-75% by weight of the carbon fiber powder.

The homogeneous mixture preferably contains a filler, such as silicon carbide powder and/or graphite powder.

It is preferable if at least some of the sheets, in particular all sheets, made of carbon material have a material density in the region of approximately 0.5 g/cm³ to approximately 0.85 g/cm³.

The carbon fibers are preferably produced by grinding and carbonizing viscous and/or cellulose material, in particular by first grinding and then carbonizing the material(s).

The carbon fibers are present in the mixture in the form of short chopped fibers, preferably having a fiber length distribution D₅₀<20 μm.

The carbon fibers in the mixture preferably have a fiber length distribution D₉₅<70 μm.

In accordance with a further aspect of the invention, a component made of the ceramic material is produced by the method according to the invention from a ceramic material having a material density in the range from 2.8 g/cm³ to approximately 3.1 g/cm³.

The component is formed preferably as a housing of an optical system, preferably as a housing of an optical lithography system, more preferably as a housing of an EUV lithography system.

The component formed as a housing of an optical system is preferably formed so as to hold optical components, such as lenses and/or mirrors.

In a preferred variant, the component is formed as a substrate of an optical mirror, in particular as a substrate of a mirror for an optical lithography system.

The component preferably has a spatial expansion (length×width×height) in the range from 50-150 cm (length)×50-150 cm (width)×5-150 cm (height).

It is preferable if the ceramic material of the component has a modulus of elasticity of 270 GPa or more, preferably more than 300 GPa, in particular in the range from 320 GPa to 350 GPa.

The ceramic material of the component has a flexural rigidity of 280 MPa or more, preferably 350 MPa or more, more preferably 400 MPa or more.

The ceramic material of the component has a coefficient of thermal expansion of less than 3.4×10⁻⁶/K, preferably less than 3.0×10⁻⁶/K, more preferably 2.7×10⁻⁶/K.

The ceramic material of the component has a thermal conductivity of 120 W/(mK) or more, preferably 140 W/(mK) or more, more preferably 170 W/(mK).

The product or the preform thereof is worked from the encasing body by mechanical working, in particular by cutting, sawing, drilling, milling, turning, planing and/or grinding, preferably within the scope of a CNC process.

Optical-thermal methods are also conceivable however.

Other features which are considered as characteristic for the invention are set forth in the appended claims.

Although the invention is illustrated and described herein as embodied in a method for producing a component and a component produced by the method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a flow diagram schematically explaining an embodiment of a method according to the invention for producing a product from a carbon-fiber-reinforced material;

FIGS. 2-5 are schematic flow diagrams illustrating details of different sub-steps of further embodiments of the method according to the invention for producing the product from the carbon-fiber-reinforced material;

FIGS. 6A-6F are schematic and cut side views of intermediate stages that are reached in one embodiment of the method according to the invention for producing the product from the carbon-fiber-reinforced material; and

FIGS. 7A-10D are illustrative views showing various sequences of joining processes that may be applied in other embodiments of the method according to the invention for producing the product from the carbon-fiber-reinforced material.

### DETAILED DESCRIPTION OF THE INVENTION

Embodiments of the present invention will be described hereinafter. All embodiments of the invention as well as the technical features and properties thereof can be isolated individually or electively grouped together as desired and combined without restriction.

Structurally and/or functionally like, similar or identically acting features or elements will be denoted hereinafter in conjunction with the figures by like reference signs. A detailed description of these features or elements will not be repeated in each case.

Reference is first made to the drawings in general.

The present invention also relates, inter alia, to the production of large three-dimensional or 3D structures having homogeneous property profiles.

Previously, large monolithic block structures for example were formed and worked mechanically, for example by milling or the like, so as to produce complex structures of three-dimensional structure.

In that case, it was disadvantageous that monolithically produced material blocks demonstrate severe inhomogeneities in the material distribution, whether just in respect of specific components and/or in respect of the physical and/or chemical properties. This often occurs in conjunction with fluctuations in density of one or more components and/or with the occurrence of “compression density gradients”.

To avoid these problems, the present invention proposes two-dimensional joining of predefined sheets, in particular of green body sheets, with subsequent working of the structure thus obtained by the joining process to produce a large and possibly complex object of three-dimensional or 3D structure.

There are various variants of the joining process.

In accordance with a first variant, a large structure of sheets, in particular CFC sheets, joined together two-dimensionally by an adhesive is produced. A connection may be produced under low compressive force, for example so as to prevent the adhesive agent used from penetrating the sheets. For example, the adhesive has to compensate for two gaps between the sheets to be arranged one on the other and also for the different reliefs, but the interface at the joining faces should not be subject to additional or new inhomogeneities as a result of the adhesive. For example, the adhesive may consist of a mixture of phenolic resin and SiC powder. A process of siliconization may then follow. Next, the encasing structure or sandwich structure thus obtained is further worked to produce the required complex 3D structure.

Sheets of low layer thickness can be produced with practically homogeneous density and thus with practically homogeneous chemical and physical material properties. The structure of a plurality of sheets to form an encasing body or to form a sandwich structure enables subsequent mechanical working, for example by milling or the like. A structure of this type can be easily fixed and held in a corresponding milling device for example.

With the use of SiC powder as a filler in the adhesive agent, there is no change during the process of siliconization. The particle size of the silicon carbide or SiC may therefore be adapted beforehand to the particle size of the SiC particles in the main body at the gluing point, that is to say at the interface between the joining faces, such that similar material properties and therefore similar physical and/or chemical properties compared to the rest of the sheet material are produced at the joining point between the joining faces. This increases the homogeneity of the entire product.

With regard to the particle size distribution of the SiC powder, sieving with sieve size F1200 is preferable.

In a further embodiment, the encasing body or volume body is constructed from partially cross-linked sheets, that is to say from sheets having a partially cross-linked basic material, which are interconnected two-dimensionally and without adhesive. The connection is made under a compressive force greater than in the variants described above, since no adhesive is used. However, a powder originating from the same material class as the basic material or the basic materials of the underlying sheets may be scattered between the joining faces to assist the connection. Carbonization with subsequent siliconization is then performed. The encasing body or the sandwich structure is then mechanically worked again to form the complex 3D structure of the desired product.

A material having a fiber size in the green body of approximately 10 μm can be used to produce highly rigid structures. In a finished CSiC component for example, this provides silicon carbide grains having a size of approximately 20 μm and therefore a comparatively fine structure. Flexural rigidities of more than 280 MPa, with moduli of elasticity of more than 300 MPa, with thermal conductivities of more than 120 W/m·K, with CTE values of less than 3.4 and specific thermal capacities cp of more than 0.68 J/g·K, can therefore be produced.

It is important for the invention that the joining point, that is to say the interface between the joining faces or at the joining faces, must always be similar in terms of material and its properties to the material of the main body. For example, this means that SiC grains must have a similar grain size as the SiC grains in the main body. There must be no carbon residue present at the joining faces, that is to say at the interface between the joining faces, since atomic hydrogen present could react, during operation or further processing, with a residual carbon to form volatile hydrocarbon compounds or CH compounds. The processes of evaporation occurring in this instance could have a disadvantageous effect.

It is also important that only small influences, if any, are exerted on the properties of the interfaces when using adhesives. Depending on the circumstances, it may be advantageous if the adhesive is selected and formed such that it does not react during the process of siliconization, and in particular does not expand or shrink. Adhesives containing SiC particles may therefore be used so that the same mechanical properties as in the main body result at the interfaces of the joining faces after siliconization.

Reference will now be made to the drawings in detail.

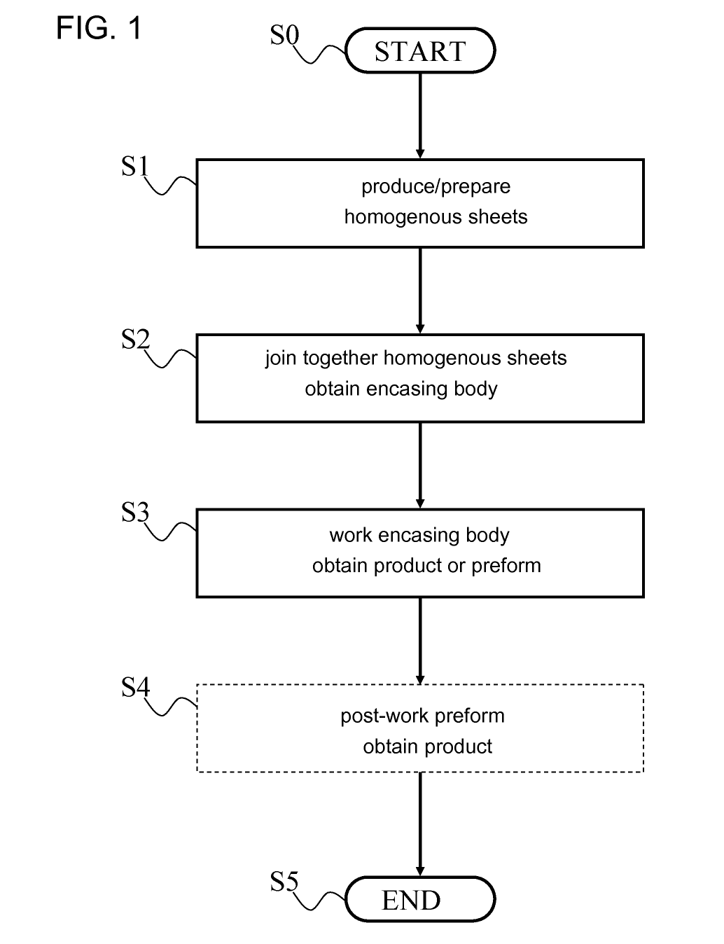

FIG. 1 shows a schematic block or flow diagram illustrating a first embodiment of the method according to the invention for producing a product 200 from a carbon-fiber-reinforced material 10′ having a predefined three-dimensional structure R.

In an initial step S0, all precautions necessary for the method are taken.

In a subsequent step S1, a plurality of homogeneous sheets 10 are produced or provided. These sheets 10 are formed from the carbon-fiber-reinforced material 10′ or a preform 10″ thereof. The sheets 10 are preferably identical or substantially identical, but at least comparable, in terms of geometry and their chemical and/or physical properties, more specifically in such a way that any variation in their natural properties, if present, is not disadvantageous to the properties of the end product, namely the product 200.

The provided sheets 10 are joined together in the subsequent step S2. As a result, an encasing body 100, which has a specific three-dimensional structure R′ is created. The encasing body 100 is dimensioned such that it at least encases the desired product 200 and the three-dimensional structure R thereof. At best, the three-dimensional structure R′ of the encasing body 100 is identical to the three-dimensional structure R of the product 200 to be produced. This is not necessary however, and in general is not the case.

Following the joining process in step S2, the encasing body 100 is then worked in the subsequent step S3 so as to obtain therefrom the product 200 or the preform 200′ thereof.

Within the meaning of the invention, a preform 200′ is always provided in respect of the desired product 200 if, after working, that is to say after working out the three-dimensional structure R actually desired, further intermediate working steps or post-working steps are necessary, for example carbonization, siliconization and/or the like.

The last-mentioned steps can then be contained in the optional method block S4 of the post-working of the preform 200′ to obtain the product 200.

The measures for finishing the method are then taken in the subsequent step S5.

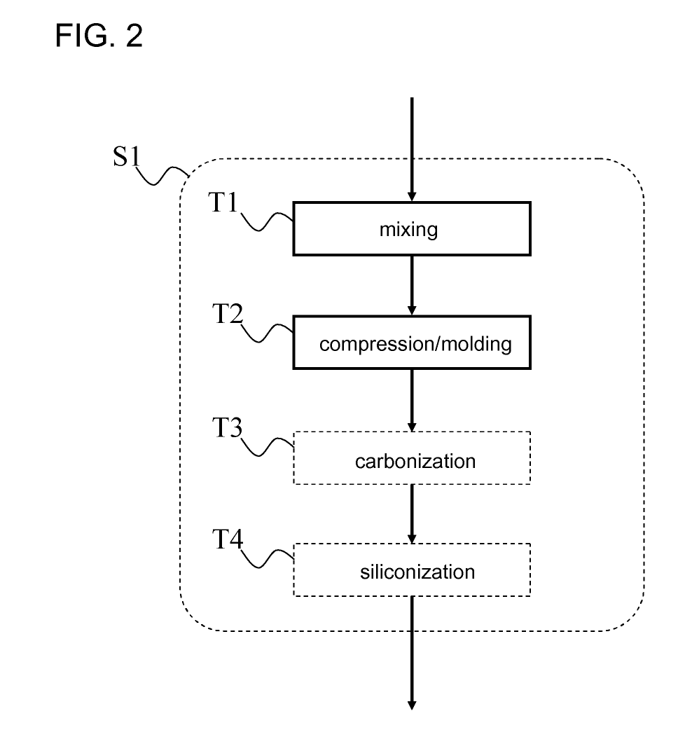

FIGS. 2 to 5 show subordinate block or flow diagrams illustrating possible details of steps S1, S2 and S4, which may be provided in some embodiments of the method according to the invention for producing a product 200 from a carbon-fiber-reinforced material 10′.

According to FIG. 2, instead of a mere provision of sheets 10 already prefabricated, step S1 may also include production of these sheets 10. For example, a production sub-method of this type includes the steps T1 of mixing the material components required for the sheets 10, the step T2 of molding or compressing the components mixed in step T1 to form corresponding sheets 10, whether planar or curved, and optional steps T3 of carbonization and T4 of siliconization.

The last-mentioned steps T3 of carbonization and T4 of siliconization are optional in this instance, because in many cases it is advisable, after the step T2 of compressing or demolding the sheets, to first form the encasing body 100 by joining together the sheets 10 with the sheets in their basic form, that is to say in the substantially non-post-worked form of the sheets 10, that is to say as a green product or green body. Due to the changing material properties with carbonization T3 and siliconization T4, certain further processing procedures are easier to implement in the basic form.

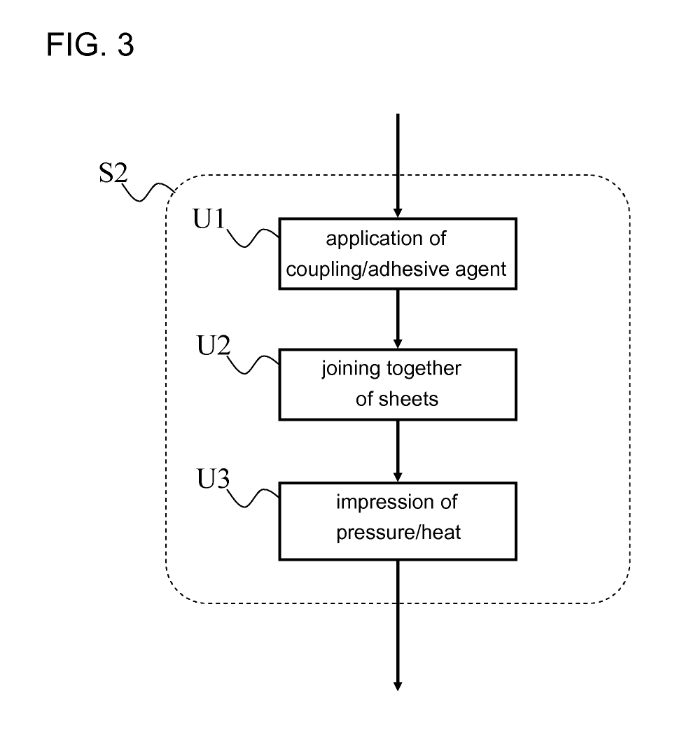

The flow diagram in FIG. 3 shows sub-steps of the joining process S2 of the sheets 10 in one embodiment of the method according to the invention for producing a product 200 from a carbon-fiber-reinforced material 10′. In this embodiment a coupling agent or adhesive agent 20 is applied U1, before the actual joining of the sheets 10, either to one of the joining faces 10o, 10u, 10k or part thereof or to all joining faces 10o, 10u, 10k or parts thereof.

The actual joining of the sheets 10 then takes place in the next step U2.

The joining process is then optionally assisted for a specific period of time by a step U3 of impressing pressure and/or heat.

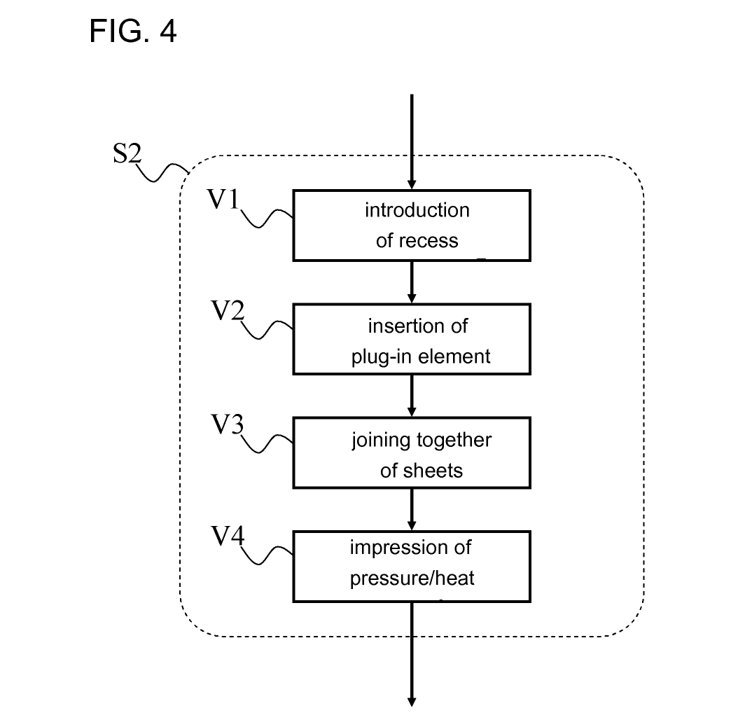

FIG. 4 illustrates an alternative procedure for joining S2 the sheets 10. In this case, a recess 32 is formed in at least one of the sheets 10 in a first step V1. Two sheets 10 to be interconnected may also be formed with recesses 32.

In a subsequent step V2, a prepared plug-in element 31 is then inserted into the recess 32 or the recesses 32.

In the following step V3, the sheets 10 are then joined together, wherein the plug-in elements 31 in the recesses 32 assist the alignment and/or joining of the sheets 10 relative to one another.

In an optional step V4, pressure and/or heat may then again be impressed on the structure so as to assist the connection.

With regard to step V2, it is necessary for a separate plug-in element 31 to be prepared for insertion into the recesses. Rather, the plug-in element 31 may also be part of one of the sheets 10.

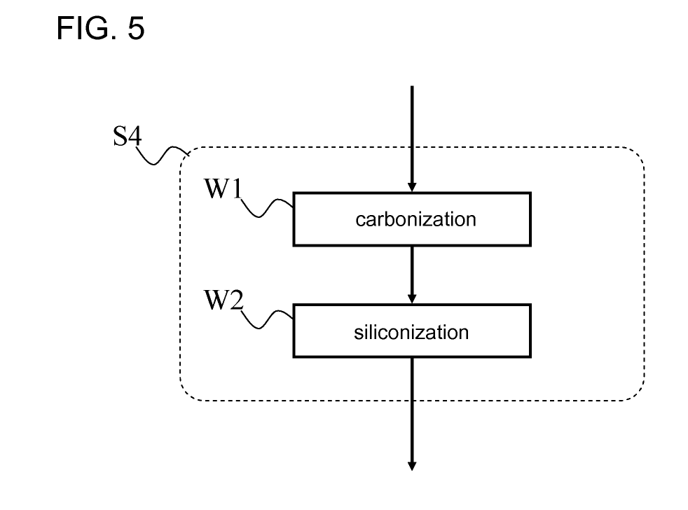

FIG. 5 lastly shows the optional step S4 as a step of carbonization W1 and siliconization W2 following the mechanical working or working out S3.

Due to the carbonization W1, specific or all carbonaceous components of the materials 10′, 10″ forming the basis of the sheets 10 are converted into carbon structures, for example by pyrolysis or the like, wherein silicon is then taken up in the subsequent step W2 into the structures thus created, namely so as to form the corresponding ceramic structure.

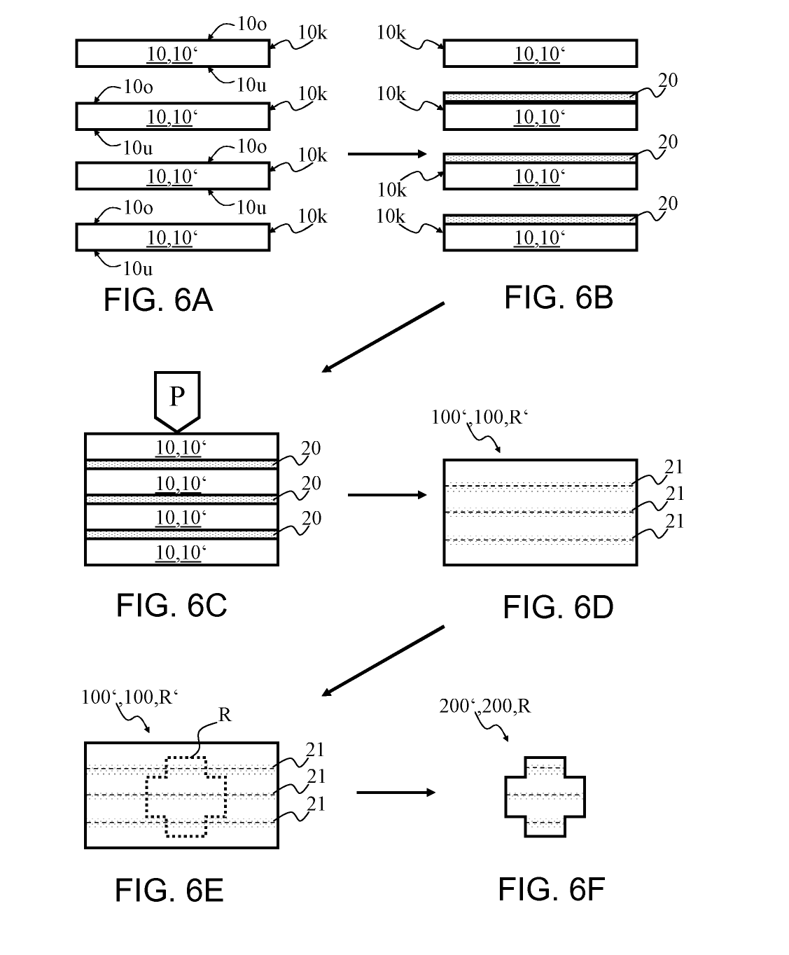

The sequence of FIGS. 6A to 6F describes details of another embodiment of the method according to the invention for producing a product 200 from a carbon-fiber-reinforced material 10′.

In the intermediate state illustrated in FIG. 6A, a plurality of identical sheets 10 made of the carbon-fiber-reinforced material 10′, each having an upper side 10o and an underside 10u as well as edges 10k, are first provided and arranged in place.

In the transition to the intermediate state illustrated in FIG. 6B, layers of a coupling agent 20, for example of an adhesive 20, are then applied to the upper sides 10o of the sheets 10, excluding the uppermost sheet. It is also conceivable for the respective upper sides and undersides 10o and 10u assigned to one another to be provided with the adhesive agent 20.

In the transition to the intermediate state illustrated in FIG. 6C, the sheets 10 are then joined together in the manner of a stack under the action of a pressure P, wherein the upper side 10o of a lowermost sheet 10 in each case receives the underside 10u of a respective sheet 10 arranged thereabove, with the adhesive 10 between.

Under the action of the pressure P, the sheets 10 are thus joined together in the transition to the intermediate state in FIG. 6D to form an encasing body 100 or preform 100′ thereof. In this case, the interfaces 21 between the sheets 10 previously provided separately are not illustrated.

In the transition to the intermediate state illustrated in FIG. 6E, the process of working the three-dimensional structure R of the desired product 200 or preform 200′ thereof from the encasing body 100 or preform 100′ thereof is begun.

In the stack of the three-dimensional structure R′ of the encasing body 100 or preform 100′ thereof indicated in FIG. 6E, the outlines of the three-dimensional structure R of the body 200 or preform 200′ thereof to be produced are already indicated by a dotted line.

In the transition to the intermediate state illustrated in FIG. 6F, the product 200 or preform 200′ thereof having the three-dimensional structure R is worked from the encasing body 100 or preform 100′ thereof.

Over the sequence of FIGS. 6A to 6E, all sheets 10 are joined together via their upper sides 10o and their undersides 10u, such that a stack is created on the whole for the encasing body 100 or preform 100′ thereof.

Above and hereinafter, reference is made respectively to a preform 100′, 200′ for the encasing body 100 and for the product 200 to be produced if processing steps, such as carbonization or siliconization, are still necessary after the respective fabrication or as intermediate steps. If such steps are not necessary, reference is made directly to an encasing body 100 or product 200 respectively.

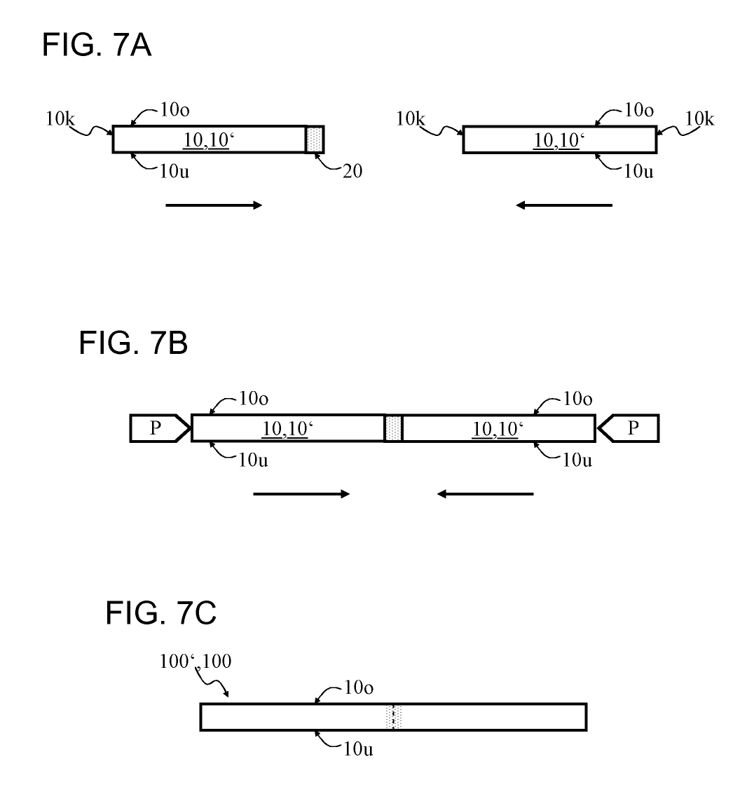

In the embodiment in FIGS. 7A to 7C, the joining process between directly adjacent sheets 10 takes place via the edges 10k or edge faces 10k of the sheets.

In the intermediate state illustrated in FIG. 7A, two sheets 10 made of a carbon-fiber-reinforced material 10′ are joined together via their edges 10k, wherein, in FIG. 7A, the sheet 10 arranged on the left-hand side has an adhesive agent 20 in the form of an adhesive 20 at its right edge 10k.

In the transition to the intermediate state shown in FIG. 7B, the two sheets 10 are then joined together via their edges 10k and the adhesive agent 20 therebetween, wherein a suitable compressive force P is impressed from each of the opposite edges 10k.

Due to the action of the compressive force P, a connection of the two sheets 10 made of carbon-fiber-reinforced material 10′ is then achieved in the intermediate state shown in FIG. 7C, such that the encasing body 100 or preform 100′ thereof consists of a pair of sheets 10 in the intermediate state shown in FIG. 7C. In principle however, two-dimensional objects containing more than two sheets are also conceivable.

In the approach according to the sequence of FIGS. 7A to 7C, no further aids apart from the adhesive agent 10 at the edge faces 10k were used to join together the sheets 10.

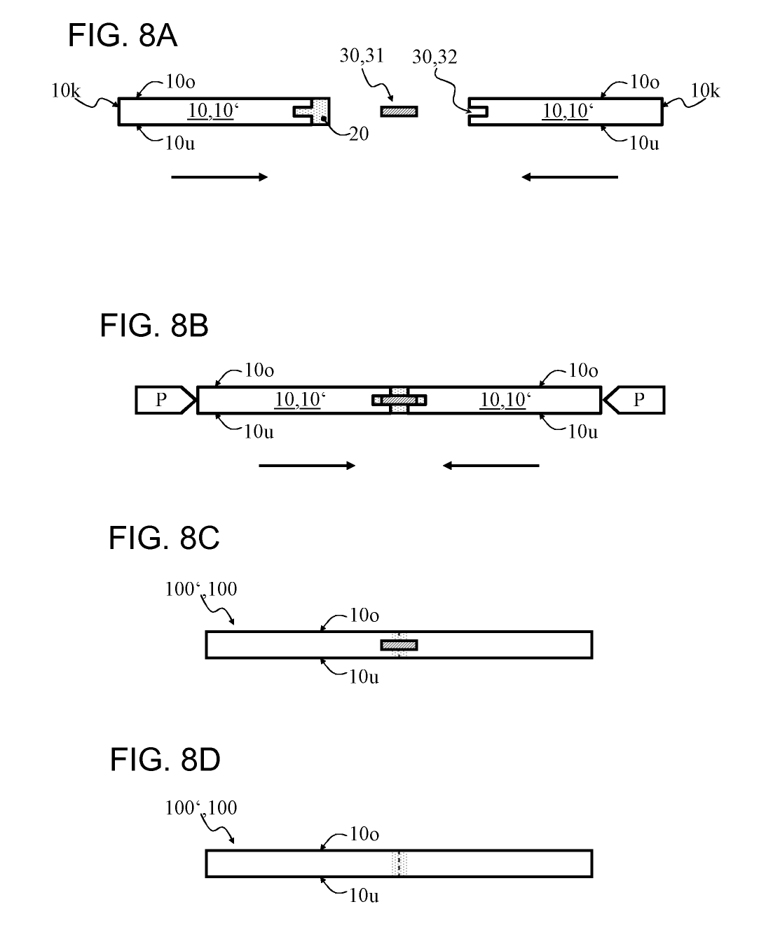

By contrast, in the sequence of FIGS. 8A to 8D, recesses are formed in the edge faces 10k of the sheets 10 made of the carbon-fiber-reinforced material 10′ and mutually opposed via the edge faces 10k. These recesses are shaped in a manner complementary to and cooperating with an additionally provided plug-in element 31, such that the intermediate structure illustrated in FIG. 8B is first produced when the sheets 10 and their recesses 32 are joined cooperatively to the plug-in element 31, wherein, due to the adhesive agent 20 additionally provided on the left-hand side in the recess 32, a type of embodiment of the plug-in element 31 in the recesses 32 occurs with wetting by the adhesive agent 20.

In the transition to the intermediate state illustrated in FIG. 8C, a structure in which the two sheets 10 are joined together to form the encasing body 100 or preform 100′ thereof is produced under the action of the pressure P, wherein the plug-in element 31 is also clearly visible at the interface 21 between the previously separate sheets 10.

With a suitable selection of the material for the plug-in element 31 and the adhesive agent 20, the differences at the interfaces can be suitably remedied, such that a substantially homogeneous structure is also provided at the interface 21, that is to say the plug-in element 21 can no longer be materially detached once the individual sheets 10 have been joined together, as is illustrated in the arrangement in FIG. 8D.

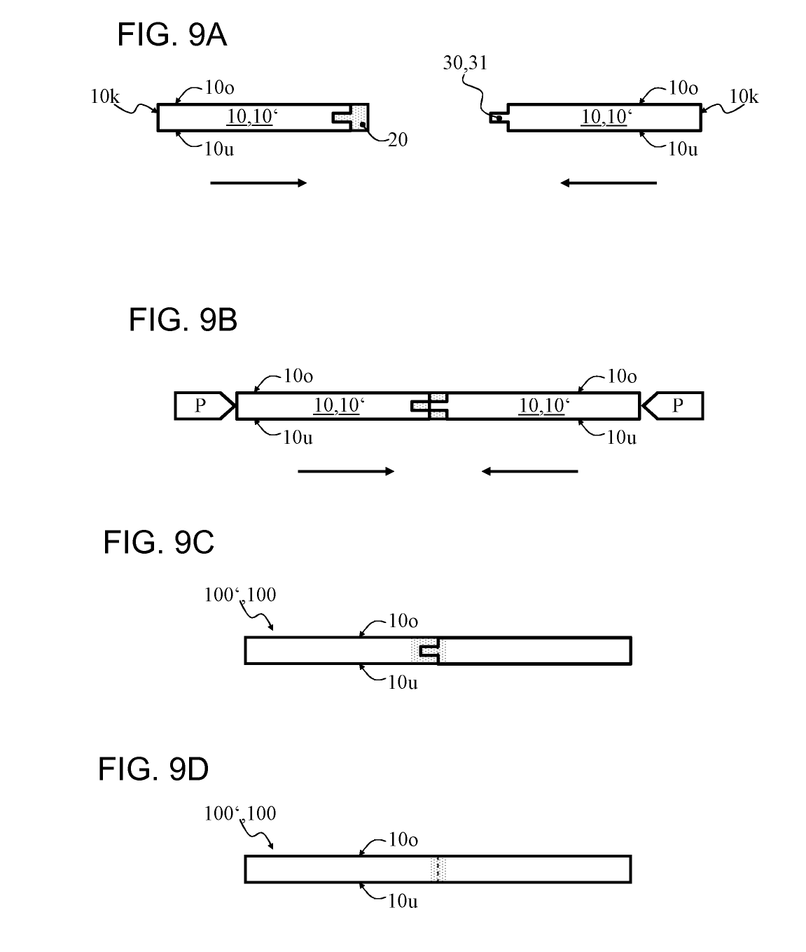

The sequence in FIGS. 9A to 9D describes an approach similar to the sequence in FIGS. 8A to 8D, but in this case a separate plug-in element 31 is not formed, but rather the plug-in element 31 is formed integrally with, that is to say as part of, the right-hand sheet 10 made of the carbon-fiber-reinforced material 10′. Again, an adhesive agent 20 is filled into the recess 32 in the other sheet 10 so that the encasing body 100 or preform 100′ thereof is obtained in accordance with FIG. 9C once the sheets have been joined together in accordance with the arrangement in FIG. 9B and a suitable pressure P has been applied, wherein material detachment of the previously separate sheets 10 and of the interfaces 21 is no longer possible with suitable material selection in accordance with FIG. 9D.

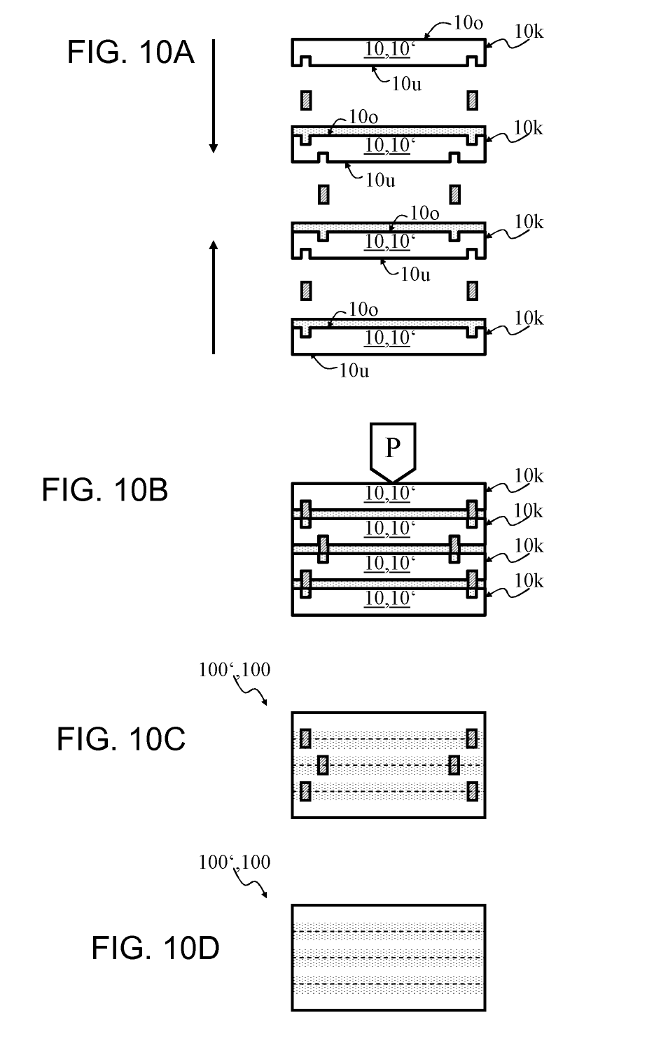

The sequence in FIGS. 10A to 10D shows an approach in which recesses 32 and plug-in elements 31 are not inserted at the edges 10k, but for connection of the upper sides 10o and undersides 10u of the sheets 10 made of carbon-fiber-reinforced material 10′.

According to FIG. 10A, recesses 32 are formed in the upper sides 10o and undersides 10u of directly adjacent sheets 10. Furthermore, separate plug-in elements 31 are provided in this instance. In each case, the upper side 10o of the lowermost sheet 10 is coated with an adhesive agent 20.

In the transition to the intermediate state shown in FIG. 10B, the directly adjacent sheets 10 made of carbon-fiber-reinforced material 10′ are joined together under the action of pressure, wherein the plug-in elements 31 are plugged into the respective recesses 32 assigned to one another and the adhesive agent 20 between the upper sides and undersides 10o and 10u respectively provides the connection.

In the transition to the intermediate state shown in FIG. 10C, the sheets 10 are then joined together such that the encasing body 100 or preform 100′ thereof is obtained. In this case, in the arrangement in FIG. 10C, the plug-in elements 31 can also be seen clearly in the interfacial regions 21. A material detachment in accordance with FIG. 10C is no longer possible with suitable selection of the material components for the plug-in elements 31 and of the adhesive 20, as indicated in FIG. 10D.

### LIST OF REFERENCE SIGNS

10 sheet, sheet element
10′ material of the sheet/sheet element 10, carbon-fibre-reinforced material
10k edge, edge face, edge region
10o upper side, upper face
10u underside, lower face
20 coupling aid, coupling agent, adhesive agent, bonding agent
21 interface, interfacial region
30 connection means
31 plug-in means, plug-in element
32 recess, groove, bore, channel
100 encasing body, encasement body
100′ preform of the encasing body
200 product
200′ preform of the product
R three-dimensional structure, 3D structure of the product
R′ three-dimensional structure, 3D structure of the encasing body 100/preform
100′ thereof

1. A method for producing a component made of a ceramic material having a predefined shape, which method comprises the steps of:
providing a plurality of sheets made of a carbon material;
providing an adhesive containing a carbonizable element and joining the plurality of sheets to each other by means of the adhesive to form a sheet configuration, spatial dimensions of the sheet configuration being such that the predefined shape of the component can be generated from the sheet configuration by material removal;
working the sheet configuration by removing the carbon material from the sheet configuration for obtaining a preform made of the carbon material and having the predefined shape of the component to be produced; and
siliconizing the preform to obtain the component made of the ceramic material.

2. The method according to claim 1, which further comprises forming the sheet configuration by stacking on top of one another or joining to each other at least some of the sheets, or all of the sheets, by joining an underside of a sheet or subsequent sheet as a first joining face to an upper side of another sheet as a second joining face.

3. The method according to claim 1, wherein the sheets have side faces defined by a thickness of the sheets, and joining at least one of the sheets by one of its side faces as a first joining face to one of an upper side or underside of another of the sheets as a second joining face.

4. The method according to claim 1, wherein the sheets have side faces defined by a thickness of the sheets and at least one of the sheets is joined by one of its side faces as a first joining face to one of side faces of another of the sheets as a second joining face.

5. The method according to claim 1, wherein in a case of at least two of the sheets to be joined at joining faces, a recess is integrally formed in a joining face of one of the sheets and a protrusion shaped in a manner complementary to the recess is integrally formed on a joining face of the other sheet and the two sheets are joined together by engaging the recess with the protrusion.

6. The method according to claim 1, wherein in a case of at least two of the sheets to be joined at joining faces, a recess is integrally formed in the joining faces of both sheets, and in that a connection element shaped in a manner complementary to the recesses is provided, wherein the two sheets are joined together by engaging the connection element with both recesses.

7. The method according to claim 1, wherein the carbonizable element of the adhesive contains a resin.

8. The method according to claim 7, which further comprises forming the adhesive to contain a silicon carbide powder in addition to the resin.

9. The method according to claim 8, which further comprises forming the silicon carbide powder with a mean particle diameter of 1-50 μm.

10. The method according to claim 7, which further comprises forming the adhesive to contain 5-50% by weight water, 20-80% by weight silicon carbide powder and 10-55% by weight of the resin.

11. The method according to claim 10, which further comprises forming the adhesive to contain less than 10% by weight of a filler made of the carbon material.

12. The method according to claim 8, which further comprises forming the adhesive to contain between 0.5 and 5% by weight of a curing agent.

13. The method according to claim 1, wherein the adhesive contains a material from which the sheets made of the carbon material are fabricated.

14. The method according to claim 1, which further comprises carbonizing the sheet configuration.

15. The method according to claim 1, which further comprises carbonizing the preform.

16. The method according to claim 1, which further comprises subjecting the sheets to at least one of pressure or heat when joined together.

17. The method according to claim 1, wherein at least one of physical or chemical properties of at least some of the sheets are identical over a spatial expansion of the sheets in question.

18. The method according to claim 1, wherein at least some of the sheets have a spatial expansion in a range from 20-80 cm in length×20-80 cm in width×3-10 cm in thickness.

19. The method according to claim 1, wherein at least some of the sheets have a same composition of the carbon material.

20. The method according to claim 1, which further comprises:
producing at least some of the sheets by preparing a homogeneous mixture with a carbonizable, powdery binder and carbon fibers;
compacting the homogenous mixture under an action of pressure;
molding the homogenous mixture into a sheet-shaped preliminary product and
further processing the sheet-shaped preliminary product by one of carbonization or by carbonization and graphitization, to form a sheet made of the carbon material.

21. The method according to claim 20, which further comprises forming the carbonizable, powdery binder as a phenolic resin powder with a particle size distribution D₅₀<100 μm.

22. The method according to claim 20, wherein the homogeneous mixture contains 20-50% by weight of the binder and 50-80% by weight of the carbon fibers.

23. The method according to claim 20, wherein the homogeneous mixture contains a filler selected from the group consisting of a silicon carbide powder and a graphite powder.

24. The method according to claim 1, which further comprises forming at least some of the sheets from the carbon material having a material density in a region of approximately 0.5 g/cm³ to approximately 0.85 g/cm³.

25. The method according to claim 20, which further comprises producing the carbon fibers by grinding and carbonizing at least one of a viscous material or a cellulose material.

26. The method according to claim 20, which further comprises forming the carbon fibers present in the homogenous mixture in a form of short chopped fibers having a fiber length distribution D₅₀<20 μm.

27. The method according to claim 20, which further comprises forming the carbon fibers in the homogeneous mixture with a fiber length distribution D₉₅<70 μm.

28. A component, comprising:
a sheet configuration, containing:
a plurality of sheets made of a carbon material;
an adhesive containing a carbonizable element and joining said plurality of sheets to each other by means of said adhesive for defining said sheet configuration, spatial dimensions of said sheet configuration being such that a further worked predefined shape of the component can be generated from the sheet configuration by material removal; and
said sheet configuration being subjected to siliconization resulting in the component being formed from a ceramic material having a material density in the range from 2.8 g/cm³ to approximately 3.1 g/cm³.

29. The component according to claim 28, wherein the component is formed as one of a housing of an optical system, a housing of an optical lithography system and a housing of an EUV lithography system.

30. The component according to claim 28, wherein the component is a housing of an optical system and formed so as to hold optical components, including at least one of lenses or mirrors.

31. The component according to claim 28, wherein the component is a substrate of an optical mirror.

32. The component according to claim 28, wherein the component has a spatial expansion in a range from 50-150 cm of length×50-150 cm in width×5-150 cm in height.

33. The component according to claim 28, wherein said ceramic material of has a modulus of elasticity of at least 270 GPa.

34. The component according to claim 28, wherein said ceramic material has a flexural rigidity of at least 280 MPa.

35. The component according to claim 28, wherein said ceramic material of has a coefficient of thermal expansion of less than 3.4×10⁻⁶/K.

36. The component according to claim 28, wherein said ceramic material has a thermal conductivity of at least 120 W/(mK).
